(19) United States
(12) Patent Application Publication
(10) Pub. No.: US 2006/0155795 A1
(43) Pub. Date: Jul. 13, 2006

(54) Method and apparatus for hardware implementation of high performance fast fourier transform architecture

(76) Inventors: James B. Anderson, San Jose, CA (US); Wayne Marking, Carlsbad, CA (US); Tom Cesear, Carlsbad, CA (US); Rick Siviy, Carlsbad, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/298,363

(22) Filed: Dec. 8, 2005

Related U.S. Application Data
(60) Provisional application No. 60/634,454, filed on Dec. 8, 2004.

(51) Int. Cl. G06F 17/14

(52) U.S. Cl. 708/404

(57) ABSTRACT

An high performance Fast Fourier Transform implementation in hardware is achieved through placement of a number of Butterfly/Dragonfly or “FLY” cells that run concurrently during a transformation process. The bank of FLY cells interacts according to FFT/IFFT algorithms through use of a resource-sharing fabric. The resource-sharing fabric allows the bank of cells to accept raw input, exchange intermediate results according to the FLY network topology, apply phase factors at appropriate junctures, and finally generate output, which may then be digit-reversed according to particular FFT/IFFT algorithmic variant chosen, e.g. “Division In Time” or “Division In Frequency”.

### RELATED APPLICATIONS

This application claims priority to U.S. Provisional Application Ser. No. 60/634,454, filed on Dec. 8, 2004, which is incorporated herein by reference in its entirety. This application relates to U.S. patent application Ser. No. 10/072,212 entitled, “System for Architecture and Resource Specification and Methods to Compile the Specification onto Hardware,” filed on Feb. 7, 2002 by A. Nayak, et al., and U.S. patent application Ser. No. 09/770,541 entitled, “Method and Apparatus for Automatically Generating Hardware from Algorithms Described in MATLAB,” filed on Jan. 26, 2001, by P. Banerjee, et al.

### FIELD OF THE INVENTION

The present invention relates generally to an efficient Fast Fourier Transform technique and more particularly to implementing a higher performance Fast Fourier Transform in hardware such as Field Programmable Gate Arrays, Programmable Logic Devices, Application Specific Integrated Circuits, Re-configurable Computing Fabric, Data-Flow Computing Fabric, or a combination of these devices.

### BACKGROUND OF THE INVENTION

The conventional approach to hardware implementation of Fast Fourier Transform or Inverse Fast Fourier Transform (“FFT/IFFT”) is implementation of a single Butterfly or Dragonfly datapath in conjunction with buffer memory. The buffer memory is typically combined with an address generator, together serving to resolve stage-to-stage propagation of intermediate results and application of phase (“twiddle”) factors.

A common problem with the conventional approach is that it suffers from lower throughput and higher latency than desired for many applications. The conventional approach structures are limited by the fact that input/output (“I/O”) latency is dominated by a complete unwinding of the N-FLY interconnection topology.

What is needed is a method for implementing FFT/IFFT in hardware that provided greater throughput and lower latency than can be achieved by conventional approaches.

### SUMMARY OF THE INVENTION

Recent technological advances in programmable devices such as Field Programmable Gate Arrays (“FPGA”), Re-configurable Computing Fabric (“RCF”) and Data-Flow Computing Fabric (“DFCF”), have allowed practical consideration of implementation of concurrent or parallel Butterfly or Dragonfly datapaths. Due to increases in capacity and decreases in cost of newer devices, parallel or concurrent datapaths may now be efficiently implemented in current technology programmable and application specific devices such as ASIC, FPGA, or RCF.

Performance improvements associated with concurrent or parallel computation are manifold and well understood. The present invention according to one embodiment is fundamentally a concurrent processing approach to calculation of FFT/IFFT. The present invention capitalizes on the performance attributes associated with the concurrent or parallel computation. In general, these performance attributes provide higher throughput and smaller latencies.

According to an embodiment of the present invention, the approach to construction of “FastFFT” is placement of a number of Butterfly/Dragonfly or “FLY” cells. These FLY cells may be any Butterfly/Dragonfly cell generally used with hardware implementations of FFT/IFFT such as the “Cooley-Tukey” or “Gentlemen-Sande” variants. The FLY cells are intended to run concurrently. The bank of FLY cells interacts according to FFT/IFFT algorithms through use of a resource-sharing fabric. The resource-sharing fabric allows the bank of cells to accept raw input, exchange intermediate results according to the FLY network topology, apply phase factors at appropriate junctures, and finally generate output, which may then be digit-reversed according to the particular FFT/IFFT algorithmic variant chosen, e.g. “Division In Time” (“DIT”), or “Division In Frequency” (“DIF”).

The features and advantages described in the specification are not all inclusive and, in particular, many additional features and advantages will be apparent to one of ordinary skill in the art in view of the drawings, and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a block diagram of a scalable FastFFT hardware implementation of the resource shared FLY blocks according to one embodiment of the present invention.

FIG. 2 illustrates a top-level block diagram of a system using a bank of Resource Shared FLY (“RS-FLY”) cells according to one embodiment of the present invention.

### DETAILED DESCRIPTION OF THE INVENTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

The present invention implements a resource-sharing fabric which takes advantage of the fact the total number of distinct inter-stage references are totally deterministic and, for example, may be encoded in ROM. The number of inter-stage references are limited by the expression log_{RADIX}(N), where “RADIX” is both the FLY order and logarithmic base of the chosen FFT, and “N” the FFT order, or equivalently, the number of input samples. Thus, interconnection order at any resource-shared FLY, i.e. any single member of the FLY bank, grows logarithmically. As result, the entire resource-sharing fabric may be shown to grow logarithmically with FFT/IFFT order and therefore represents inherently “scalable” datapath architecture.

Resource sharing occurs over the number of stages required to implement the FFT. The number of stages is again equal to log_{RADIX}(N). The RAM size required at any FLY cell is proportional to this number. In one embodiment of the present invention, the size is given by the expression, 3*log_{RADIX}(N).

This represents a major advantage when mapping to virtually any of the aforementioned fabrics, e.g. FPGA, RCF, because memory technology cost and feasibility favors using many small memories as opposed to one large memory. Because the FFT/IFFT technique of the present invention is inherently distributed, embodiments can take advantage of using many small memories.

This distributive property extends to control, as well; with the exception of Fabric I/O and digit reversal of generated outputs, control is completely distributed. That is to say, each FLY block utilizes a distributed control element, synchronized with, but otherwise independent of all others. Stated differently, FLY control elements do not communicate, (i.e. via flags or tokens). In summary, the FastFFT architecture is a concurrent, distributed datapath fabric that exhibits all advantages to be associated with hardware possessing such attributes.

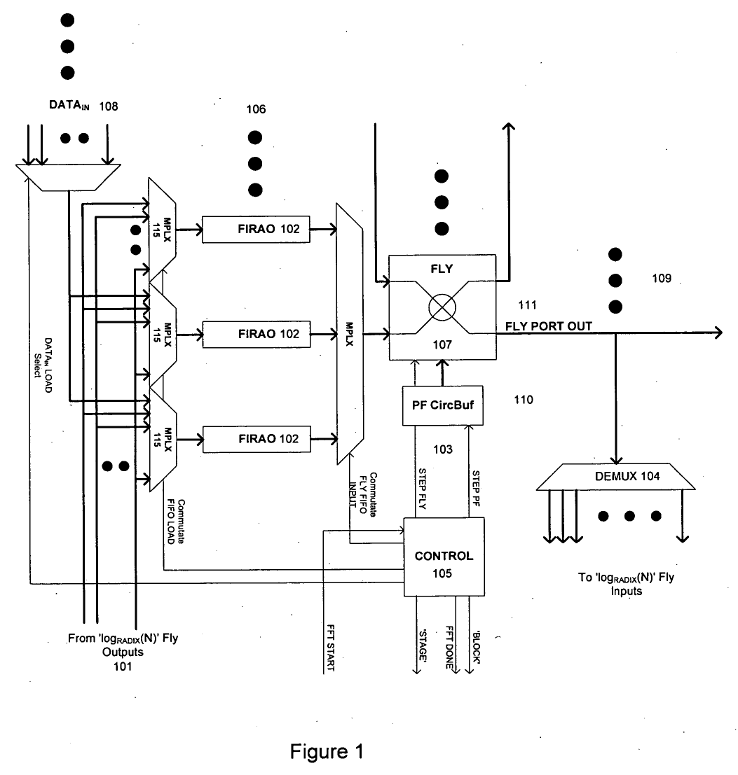

Now referring to FIG. 1, a block diagram of the FLY block implementation according to the present invention is shown. Outputs 01 shows the connection from the demultiplexer (“DEMUX”) block 104 which includes ‘log_{RADIX}(N) FLY outputs which become inputs to the three data input multiplexers (“MPLX”) 115 present on the inputs to the three First-In, Random Access Out (“FIRAO”) buffer memories 102.

The FRAO buffer memories 102 are written to in a first-in manner and read from randomly access, so as to retrieve data in a correct sequence. During FFT processing, each is concurrently being written to or read from. New input data propagated from the top level I/O and current stage outputs are written to a FIRAO 102 whereas the results of a previous inter-stage calculation is read out of a FIRAO 102. The memories are commutated based upon FFT stage and resource-sharing cycle.

FIG. 1 also shows a distributed FLY control block 105. The FLY control block synchronizes FLY cell 107 and phase factor cyclic buffer 110 operations via control lines 103. These control lines control the application of the phase factors in cyclic buffer structure 110 to the FLY cell 107.

The data input structure 106 accepts input data to the FLY cell 107. This input structure is replicated for each FLY cell 107 in the concurrent FLY cell bank.

As discussed above, the FLY cell 107 can be any generally known Butterfly or Dragonfly type, such as the Cooley-Tukey or Gentlemen-Sande methods and may be generalized to any RADIX order. The FLY cell 107 is replicated for each FLY block in the FLY bank. The number of FLY blocks in the FLY bank corresponds to the order of concurrency desired. Each FLY cell generates two outputs 111. The outputs are also replicated for each FLY block in the FLY bank.

Concurrent operation at a given order determines I/O data requirements. Data input 108 to the FLY block is sent to the data input multiplexers 115. Additional data inputs 108 are required for each FLY block concurrently implemented. According to one embodiment of the present invention, data I/O is interleaved parallel/serial, with de-interleave on input performed as part of FLY control block 105. Interleave on output is performed at the top-level. This top-level output 109 is valid at the completion of stage processing and is taken directly from FLY outputs 111 and is replicated over the set of FLY blocks in the FLY cell bank.

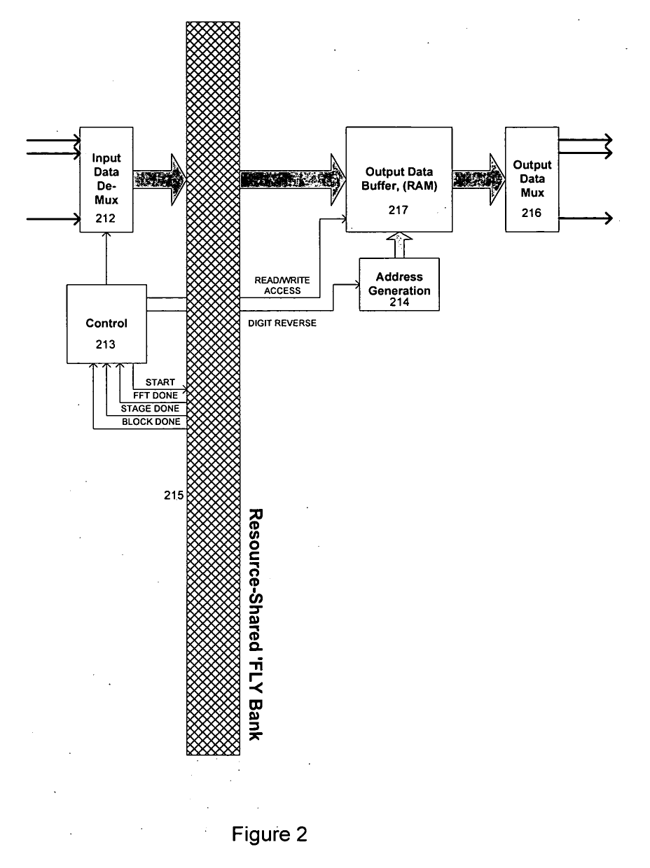

FIG. 2 illustrates a top-level block diagram of a system using a FLY bank 215 of FLY blocks illustrated in FIG. 1 according to one embodiment of the present invention. The input data DEMUX 212 provides an input data connection fabric to the FFT/IFFT core.

The top-level control block 213 controls FFT I/O, digit reversal and initiates the FFT stage processing cycle. All other control is distributed within each FLY block.

The address generation block 214 implements the digit reversal function. The address table is pre-computed and stored in a memory such as a Read Only Memory (“ROM”).

The output data buffer 217 stores an entire FFT output data-set, requiring a buffer memory size of O(N). This buffer is used for digit reversal, and thus is optional. Where digit reversal is implemented, the buffer is randomly accessed via the associated address generator so as to output data in a natural order. Bit width is determined by the real/complex data and fixed-point data width. Data is sent from the output buffer to the output data multiplexer 216 for interleaving on output as desired.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

1.) A hardware implementation of a high performance Fast Fourier Transform comprising:
an input data demultiplexer for providing input data;
at least one resource-sharing fly block coupled to the input data demultiplexer, including
at least two fly cells for performing butterfly calculations on input data;
a data input structure coupled to each fly cell for sending input data to the coupled fly cell, said data input structure including
at least one multiplexer coupled a data input and a data output demultiplexer to receive data for temporary storage; and,
a first-in, random access out buffer coupled to the at least one multiplexer for temporarily storing results of inter-stage calculations;
a fly cell control block coupled to the data input structure and a cyclic buffer for controlling the data input structure and the application of phase factors in the cyclic buffer to the at least two fly cells;
a top-level control block coupled to the at least one resource-sharing fly block for controlling data input to and output from the at least one resource-sharing fly block and initiating processing cycles; and,
an output data buffer coupled to the at least one resource sharing fly block and the top-level control block for storing the result of the high performance Fast Fourier Transform.
